(19) United States
(12) Patent Application Publication
(10) Pub. No.: US 2026/0350467 A1
(43) Pub. Date: Nov. 5, 2026

(54) INFORMATION PROCESSING APPARATUS

(71) Applicant: NEC Corporation, Tokyo (JP)

(72) Inventor: Katsushi Matsuda, Tokyo (JP)

(73) Assignee: NEC Corporation, Tokyo (JP)

(21) Appl. No.: 19/547,944

(22) Filed: Feb. 24, 2026

(30) Foreign Application Priority Data
Mar. 4, 2025 (JP) 2025-033628

(51) Int. Cl. G06N 20/00

(52) U.S. Cl. CPC G06N 20/00

(57) ABSTRACT

An information processing apparatus of the present disclosure includes a clustering unit that clusters training data used for machine learning of a machine learning model into a plurality of clusters, and a determination unit that determines whether to re-train the machine learning model based on comparison between operational data used during operation of the machine learning model and the clusters.

### INCORPORATION OF BASIC APPLICATION

The present invention is based upon and claims the benefit of the priority of Japanese Patent Application No. 2025-033628 filed on Mar. 4, 2025 in Japan, the disclosure of which is incorporated herein in its entirety by reference.

### TECHNICAL FIELD

The present disclosure relates to an information processing apparatus.

### BACKGROUND ART

Due to recent developments in deep neural network (DNN) research, machine learning models are used in various fields. For example, machine learning models that classify and monitor the state of a system or classify the medical condition of a patient are used. Meanwhile, in machine learning models, a deviation (also called data drift) of the input data after deployment from the training data used for machine learning may occur, causing performance to deteriorate with time. Therefore, re-training of machine learning models is required in which models are re-created with training data including the input data after deployment. For example, in PTL 1, operational data is classified into in-range data and out-of-range data with respect to a range of values that the data values of each data item of the training data may take, and these data tendencies are compared to determine whether re-training is required.

PTL 1: JP 2021-193497 A

### SUMMARY

However, in the technique described in PTL 1, a range of values that the data values may take is set for each data item of the training data, and each of the set ranges is uniform. For this reason, there are cases where it is not possible to appropriately cope with the data drift of operational data, making it difficult to perform re-training of a machine learning model at appropriate timing.

Therefore, one of the objects of the present disclosure is to solve the above problem that it is difficult to perform re-training of a machine learning model at appropriate timing.

An information processing apparatus that is one mode of the present disclosure has a configuration including
a clustering unit that clusters training data used for machine learning of a machine learning model into a plurality of clusters, and
a determination unit that determines whether to re-train the machine learning model based on comparison between operational data used during operation of the machine learning model and the clusters.

An information processing method that is one mode of the present disclosure has such a configuration that is executed by an information processing apparatus and includes
clustering training data used for machine learning of a machine learning model into a plurality of clusters, and
determining whether to re-train the machine learning model based on comparison between operational data used during operation of the machine learning model and the clusters.

A program that is one mode of the present disclosure causes an information processing apparatus to execute processing including
clustering training data used for machine learning of a machine learning model into a plurality of clusters, and
determining whether to re-train the machine learning model based on comparison between operational data used during operation of the machine learning model and the clusters.

With the above configurations, the present disclosure can re-train a machine learning model at appropriate timing.

### BRIEF DESCRIPTION OF THE DRAWINGS

FIG. 1 is a block diagram illustrating an example of a configuration of an information processing system according to the present disclosure;

FIG. 2 is a flowchart illustrating an example of a processing operation of the information processing apparatus according to the present disclosure;

FIG. 3 is a diagram illustrating an example of processing by the information processing apparatus according to the present disclosure;

FIG. 4 is a diagram illustrating an example of processing by the information processing apparatus according to the present disclosure;

FIG. 5 is a diagram illustrating an example of processing by the information processing apparatus according to the present disclosure;

FIG. 6 is a diagram illustrating an example of processing by the information processing apparatus according to the present disclosure;

FIG. 7 is a diagram illustrating an example of processing by the information processing apparatus according to the present disclosure;

FIG. 8 is a diagram illustrating an example of processing by the information processing apparatus according to the present disclosure;

FIG. 9 is a block diagram illustrating an example of a hardware configuration of the information processing apparatus according to the present disclosure;

FIG. 10 is a block diagram illustrating an example of a configuration of the information processing apparatus according to the present disclosure; and

FIG. 11 is a flowchart illustrating an example of a processing operation of the information processing apparatus according to the present disclosure.

### EXAMPLE EMBODIMENT

### First Example Embodiment

A first example embodiment of the present disclosure will be described with reference to the drawings. The drawings may relate to any example embodiment.

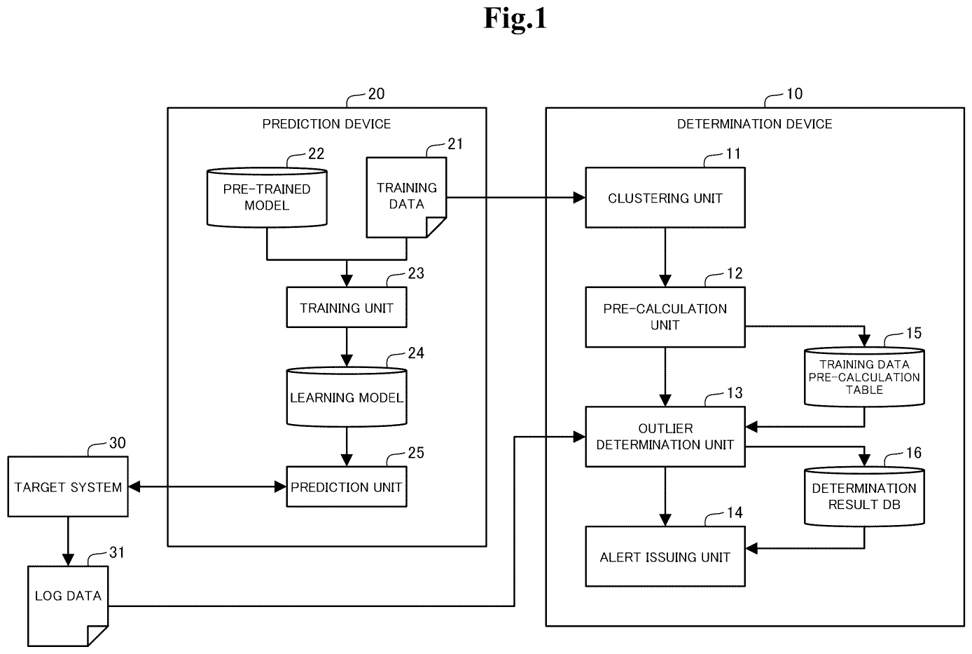

For example, an information processing system of the present disclosure is used to determine the timing to re-train a trained machine learning model that predicts and classifies the state of a system to be monitored, while the trained machine learning model is in operation. As illustrated in FIG. 1, the information processing system includes a prediction device 20 that predicts the state of the target system using the learning model, and a determination device 10 that determines whether to re-train the learning model. Hereinafter, an example of a configuration and an operation of the information processing system according to the present example embodiment will be described.

The prediction device 20 includes one or more information processing apparatuses including an arithmetic device and a storage device. As illustrated in FIG. 1, the prediction device 20 includes a training unit 23 and a prediction unit 25. Each of functions of the training unit 23 and the prediction unit 25 can be achieved by the arithmetic device executing a program for achieving each function stored in the storage device.

The training unit 23 generates a learning model 24 (machine learning model) by performing machine learning on a pre-trained model 22 using training data 21 stored in advance. Note that the training data 21 includes, for example, a pair of an explanatory variable including environmental information, measurement data measured from the target system 30, or the like, and an objective variable including state information indicating the state of the target system 30, or the like.

The prediction unit 25 receives an input of the explanatory variable such as environmental information or measurement data during operation of the target system 30, inputs it to the learning model 24, and obtains a predicted state of the target system 30 that is an output from the learning model 24. Then, the input data fed to the learning model 24 and the output data are accumulated as log data 31 (operational data) used during operation of the machine learning model, and input to the determination device 10 as described later. Note that the training data that was used for machine learning of the learning model 24 is also input to the determination device 10 as described later.

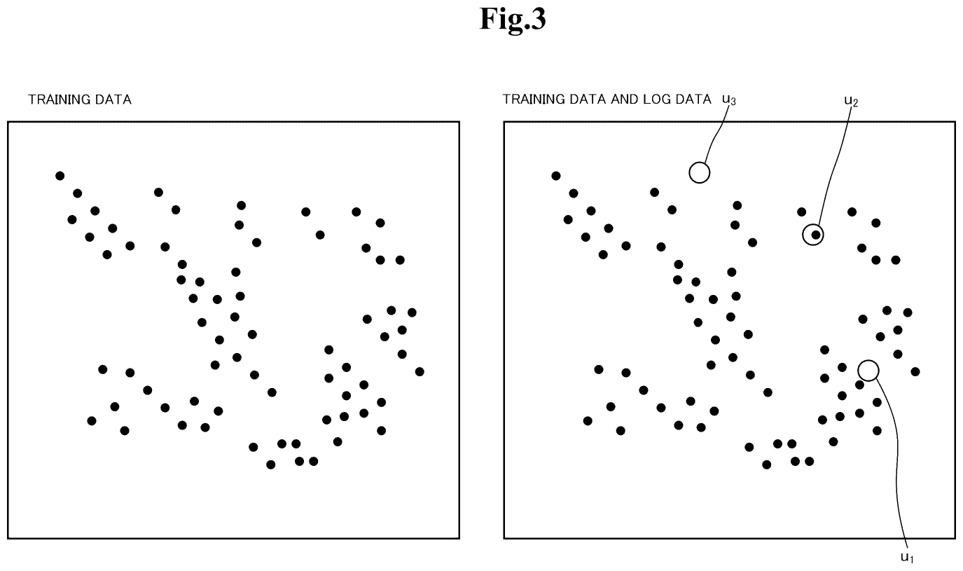

Here, FIG. 3 illustrates examples of training data and log data. Each black circle represents one piece of training data and each white circle represents one piece of log data. In the right diagram of FIG. 3, only three pieces of log data U₁ to U₃ are illustrated, together with the training data. In the example of FIG. 3, the training data and the log data are represented as two-dimensional data, but the data may be of any dimension, such as 512 dimensions.

The determination device 10 includes one or more information processing apparatuses including an arithmetic device and a storage device. Further, as illustrated in FIG. 1, the determination device 10 includes a clustering unit 11, a pre-calculation unit 12, an outlier determination unit 13, and an alert issuing unit 14. The functions of the clustering unit 11, the pre-calculation unit 12, the outlier determination unit 13, and the alert issuing unit 14 can be achieved by the arithmetic device executing a program for achieving each function stored in the storage device. In addition, a training data pre-calculation table 15 and a determination result database (DB) 16 are stored in the storage device of the determination device 10.

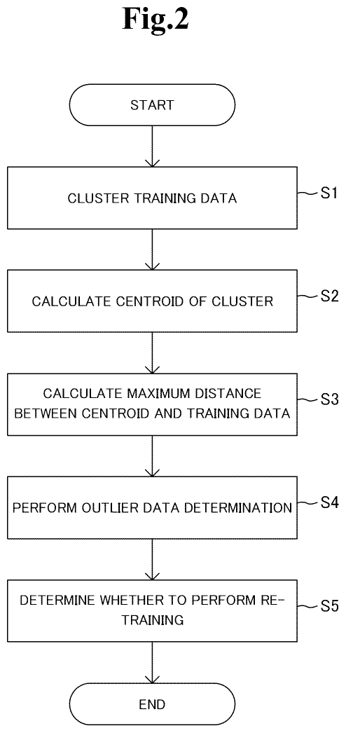

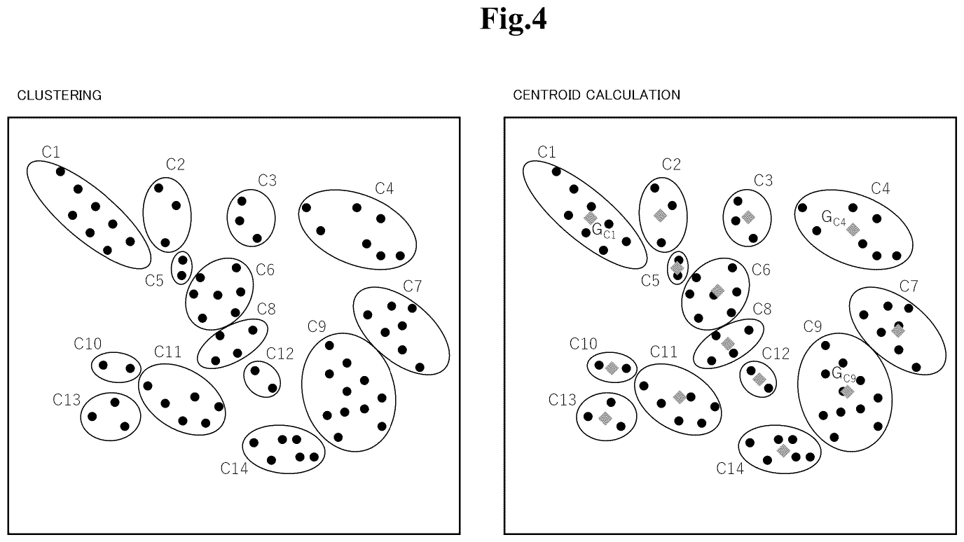

The clustering unit 11 receives an input of the training data 21 that was used for machine learning of the learning model 24 as described above, and clusters the training data 21 (step S1 in FIG. 2). At this time, the clustering unit 11 clusters the data into a plurality of clusters C without considering the labels of the training data, that is, the objective variable of the training data. Here, the left diagram of FIG. 4 illustrates a state in which the training data has been clustered into a plurality of clusters C. In the example of FIG. 4, the training data is clustered into a plurality of clusters C1 to C14. Although the number of clusters is not particularly limited, it may be, for example, about 2 to 6 times the number of labels of the training data. Furthermore, for example, the number of clusters may be set such that all the maximum distances D calculated as described later are longer than all the distances between the centroids G. In this case, the clustering unit 11 may perform clustering again according to the calculation of the centroids G and the maximum distances D by the pre-calculation unit 12 described below.

The pre-calculation unit 12 (clustering unit) first calculates the centroid G of each cluster C (step S2 in FIG. 2). For example, the pre-calculation unit 12 calculates, for each cluster, the centroid coordinates G of the coordinates of all the pieces of training data belonging to the cluster. Here, in the right diagram of FIG. 4, the centroid coordinates calculated for each cluster are indicated by a gray diamond. However, in the right diagram of FIG. 4, for convenience of explanation, only centroid coordinates G_{c1}, G_{c4}, and G_{c9} of the clusters C1, C4, and C9 are denoted by reference signs.

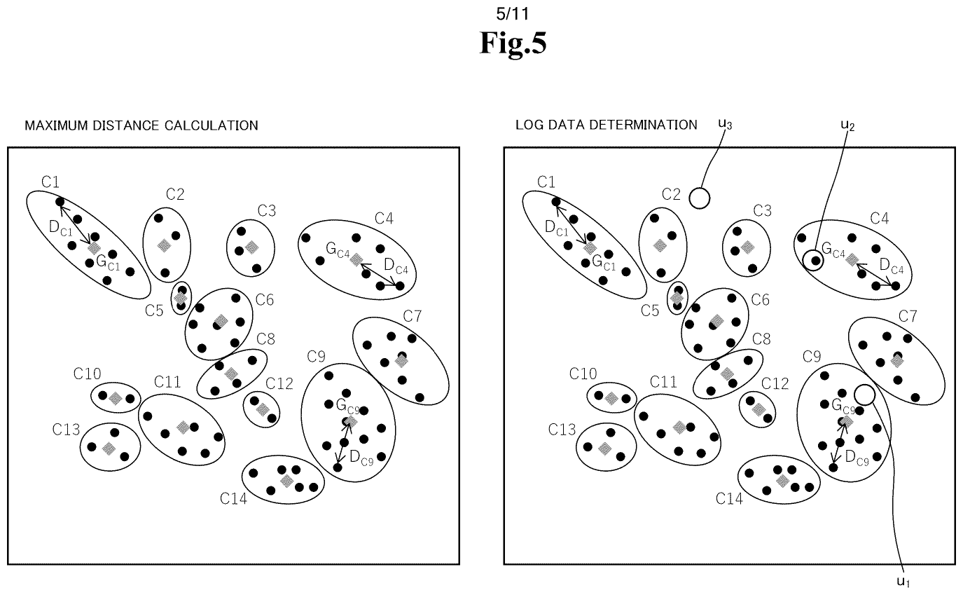

In addition, the pre-calculation unit 12 calculates, for each cluster, a maximum distance D which is the distance from the centroid coordinates of the cluster to the farthest piece of training data among the pieces of training data belonging to the cluster (step S3 in FIG. 2). For example, the pre-calculation unit 12 calculates, for each cluster, distances between the centroid coordinates of the cluster and the coordinates of all the pieces of training data belonging to the cluster, and determines the maximum distance D among all the distances. Here, in the left diagram of FIG. 5, the maximum distance D calculated for each cluster is indicated by an arrow. However, in the left diagram of FIG. 5, for convenience of explanation, only the maximum distances D_{c1}, D_{c4}, and D_{c9} from the centroid coordinates G_{c1}, G_{c4}, and G_{c9} of the clusters C1, C4, and C9 are illustrated.

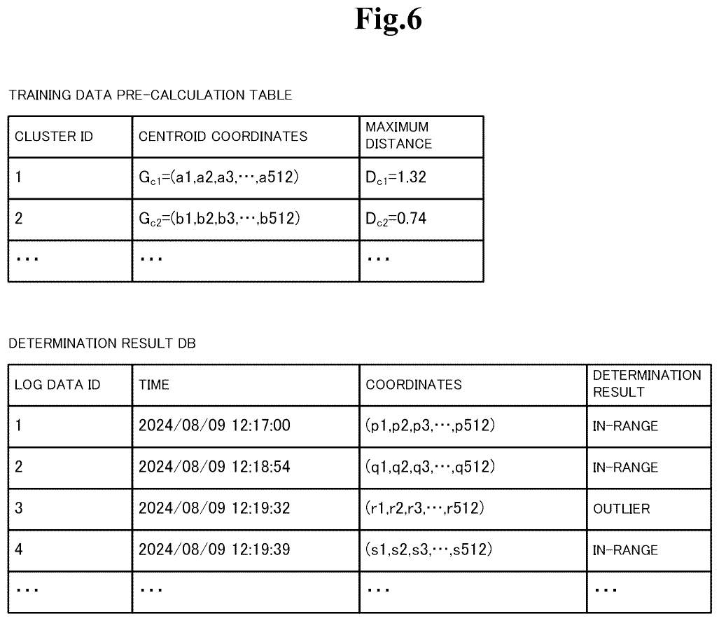

Then, as illustrated in FIG. 6, the pre-calculation unit 12 stores the calculated centroid coordinates G and maximum distance D of each cluster in the training data pre-calculation table 15. Note that the centroid coordinates G and the maximum distance D calculated for each cluster C set the range of the cluster C. That is, for a certain cluster C, the range of the maximum distance D from the centroid coordinates G represents a circular range with a radius D centered on the centroid coordinates G, and represents the range of the cluster C.

The outlier determination unit 13 (determination unit) determines whether the log data u with which the state of the target system 30 has been predicted by the prediction device 20 is outlier data that is not located in the range of each cluster C (step S4 in FIG. 2). Specifically, the outlier determination unit 13 first acquires the log data u every time a piece of log data is generated or every time a predetermined number of pieces of log data are generated and accumulated. Then, the outlier determination unit 13 calculates, for each cluster C, the distance from the centroid coordinates G of the cluster C to the coordinates of the log data u, and checks whether the distance to the log data u is equal to or less than the maximum distance D of the cluster C. That is, for each cluster C, it is checked whether the coordinates of the log data u are located within a range formed from the centroid coordinates G of the cluster C to the maximum distance D. Then, the outlier determination unit 13 determines log data u that falls outside the range of every cluster C as outlier data, and determines log data located within the range of any of the clusters C as in-range data.

Note that the outlier determination unit 13 may identify the cluster C having centroid coordinates G closest to the coordinates of the log data u, and determine the log data u to be in-range data when the distance between the centroid coordinates G of the identified cluster C and the coordinates of the log data u is equal to or less than the maximum distance D of the identified cluster C. Then, when the log data u is not within the range of the identified cluster C, the outlier determination unit 13 further checks whether the log data u is within the range of another cluster C, and determines that the log data u is outlier data when the log data u is not within the range of any cluster C.

Here, the right diagram of FIG. 5 illustrates how the log data determination is carried out. Since pieces of log data u₁ and u₂ are located within the ranges of the clusters C9 and C4, respectively, they are determined to be in-range data. On the other hand, since a log data u₃ is not located within the range of any cluster, it is determined to be outlier data. Note that, although the ranges of the clusters are represented by ellipses in FIG. 5, in practice, they have a circular shape having a radius of the maximum distance D and centered on the centroid G.

Then, the outlier determination unit 13 stores the determination result of each piece of log data in the determination result DB 16. For example, as illustrated in FIG. 6, the outlier determination unit 13 stores the log data ID, the time when the log data was generated, the coordinates of the log data, and the determination result.

The alert issuing unit 14 (determination unit) determines whether to re-train the learning model 24 based on the outlier data determined as described above (step S5 in FIG. 2). For example, the alert issuing unit 14 determines to re-train the learning model 24 in a case where the number of pieces of outlier data is equal to or larger than a preset threshold value. Furthermore, as another example, the alert issuing unit 14 may determine whether to re-train the learning model 24 based on the ratio between a number of pieces of outlier data O₁ and the sum of a number of pieces of training data N₀ and the number of pieces of log data N₁. For example, it may be determined to perform re-training in a case where the following determination formula is satisfied.

O₁/(N₀+N₁)≥0.01

Then, in a case where it is determined that re-training is to be performed based on the outlier data, the alert issuing unit 14 issues an alert for notifying the user, such as an administrator, of the re-training. Note that the alert issuing unit 14 may issue an alert by determining whether to perform re-training as described above every time log data is acquired and outlier data is determined.

As described above, in the present disclosure, training data used to train the learning model is clustered, and the range of each cluster is compared with operational data input during operation of the learning model. This makes it possible to detect the data drift of operational data that falls outside the clusters and determine that re-training of the learning model is required. This facilitates performing re-training of the learning model at appropriate timing.

### Second Example Embodiment

Next, a second example embodiment of the present disclosure will be described with reference to the drawings. The drawings may relate to any example embodiment.

An information processing system in the present example embodiment has a configuration similar to that of the above-described first example embodiment. In addition, the information processing system includes the following configuration. Hereinafter, a configuration different from the above will be mainly described.

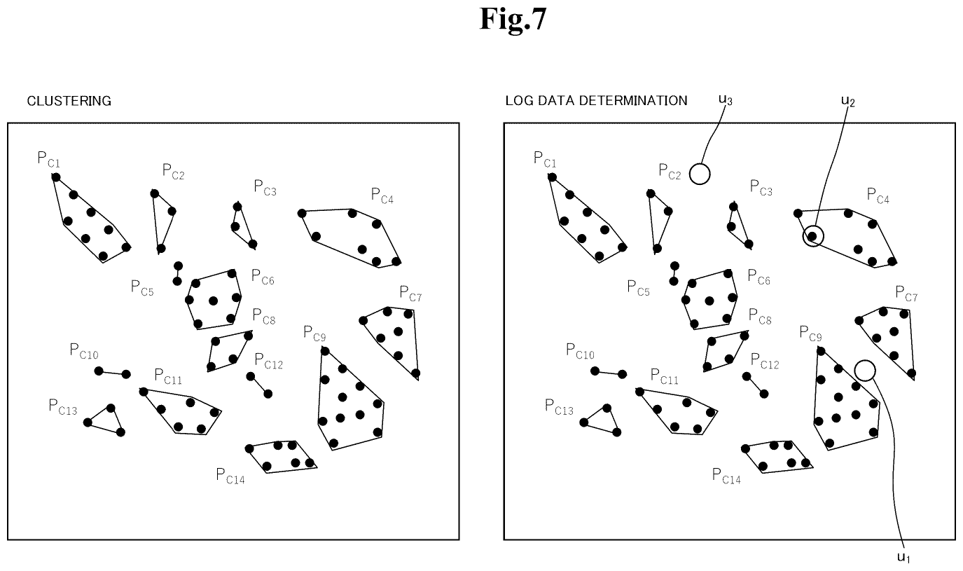

The pre-calculation unit 12 (clustering unit) of the determination device 10 included in the information processing system according to the present example embodiment approximates the range of each cluster C to a shape different from the circular shape described above. For example, the pre-calculation unit 12 creates, for each cluster C, a largest convex polyhedron P that can be formed by all the pieces of training data belonging to the cluster, and obtains equations of all planes. As a result, the range determined by the equation of the convex polyhedron P is set as the range of the corresponding cluster. For example, as illustrated in the left diagram of FIG. 7, the pre-calculation unit 12 creates convex polyhedrons P_{c1} to P_{c14} for each cluster C, and sets the range of each convex polyhedron P as the range of the cluster.

Then, the outlier determination unit 13 determines whether the log data u is outlier data according to whether the log data u is located within the range of the convex polyhedron P of each cluster. In the right diagram of FIG. 7, since the log data u₂ is located within the range of the cluster C4, it is determined to be in-range data. On the other hand, since the pieces of log data u₁ and u₃ are not located within the range of any cluster, they are determined to be outlier data.

Note that the pre-calculation unit 12 may approximate the range of a cluster C to any shape. For example, the pre-calculation unit 12 may set the range of a cluster C to a shape defined by a curve encompassing all the pieces of training data belonging to the cluster C.

### Third Example Embodiment

Next, a third example embodiment of the present disclosure will be described with reference to the drawings. The drawings may relate to any example embodiment.

An information processing system in the present example embodiment has a configuration similar to that of the above-described first example embodiment. In addition, the information processing system includes the following configuration. Hereinafter, a configuration different from the above will be mainly described.

The alert issuing unit 14 (determination unit) of the determination device 10 included in the information processing system according to the present example embodiment may determine whether to re-train the learning model based on the number of outlier data O₁ by using a determination formula different from the one described above. In this case, first, when determining whether the log data u is outlier data, the outlier determination unit 13 also determines whether the log data u matches training data. When the log data u matches training data, the outlier determination unit 13 counts the number of such pieces of log data u as a number of pieces of matching log data M₁. Then, the alert issuing unit 14 determines whether to re-train the learning model 24 based on the ratio between the number of pieces of outlier data O₁ and the value obtained by subtracting the number of pieces of matching log data M₁ from the sum of the number of pieces of training data N₀ and the number of pieces of log data N₁. For example, it may be determined to perform re-training in a case where the following determination formula is satisfied.

O₁/(N₀+N₁−M₁)≥0.01

Furthermore, the alert issuing unit 14 may determine whether to re-train the learning model according to still another determination criterion. For example, the alert issuing unit 14 may determine whether to re-train the learning model based on the accuracy rate of the learning model. In this case, the alert issuing unit 14 acquires a number of incorrect results F₀, which is the number of pieces of training data for which predictions by the learning model 24 were incorrect, from the prediction device 20. For example, the prediction device 20 can acquire the number of incorrect results F₀ by comparing the prediction result obtained when training data was input to the learning model 24 with the objective variable set to the training data.

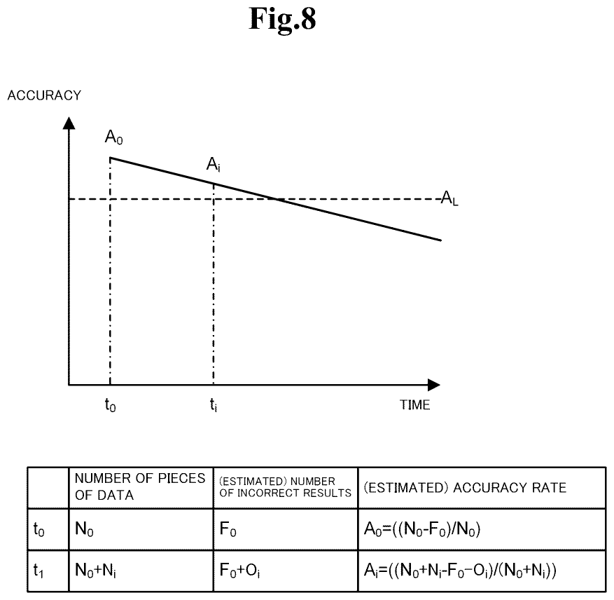

Then, as illustrated in FIG. 8 and the following formula, the alert issuing unit 14 first calculates an estimated accuracy rate Aᵢ of the learning model by obtaining the ratio of the number of estimated correct answers obtained by subtracting the number of estimated incorrect answers, which is the sum of the number of incorrect answers M₁ and the number of pieces of outlier data O₁, from the sum of the number of training data N₀ and the number of pieces of log data N₁ to the number of pieces of input data, which is the sum of the number of pieces of training data N₀ and the number of pieces of log data N₁. Note that the initial accuracy rate A₀ before the learning model is operated is expressed by the following formula.

Aᵢ=(N₀+N₁−F₀−Oᵢ)/(N₀+N₁)

A₀=(N₀−F₀)/N₀

Then, as illustrated in FIG. 8 and the following formula, in a case where the estimated accuracy rate Aᵢ falls below a preset accuracy rate lower limit A_{L}, the alert issuing unit 14 determines to re-train the learning model and issues an alert.

Aᵢ<A₀

Note that the accuracy rate lower limit value A_{L} is a value lower than the initial accuracy rate A₀ and can be appropriately set by the user.

### Fourth Example Embodiment

Next, a fourth example embodiment of the present disclosure will be described with reference to the drawings. The drawings may relate to any example embodiment.

An information processing system in the present example embodiment has a configuration similar to that of the above-described first example embodiment. In addition, the information processing system includes the following configuration. Hereinafter, a configuration different from the above will be mainly described.

The alert issuing unit 14 (determination unit) of the determination device 10 included in the information processing system according to the present example embodiment may output information used when it was determined to re-train the learning model, together with the alert described above. For example, the alert issuing unit 14 may output a determination result DB as illustrated in FIG. 6 indicating which log data is outlier data so that it is displayed to the user, such as an administrator. At this time, the alert issuing unit 14 may output temporal statistics of the outlier data using the determination result DB. For example, a distribution of the time when outlier data appeared may be generated and output.

In addition, for example, in order to visually display which log data is outlier data, the alert issuing unit 14 may display a diagram in which the positions of the pieces of log data are superimposed on the ranges of the clusters of the training data as illustrated in FIG. 5. At this time, although the training data and the log data may be three-dimensional or more, for example, as illustrated in FIG. 5, they may be simply illustrated and displayed in two dimensions by reducing the dimensionality.

### Fifth Example Embodiment

Next, a fifth example embodiment of the present disclosure will be described with reference to the drawings. The drawings may relate to any example embodiment.

An information processing system in the present example embodiment has a configuration similar to those of the above-described first to fourth example embodiments. The learning model of the present example embodiment may be used, for example, in a medical field where prediction (classification) of a disease, a disease state, or the like of a patient is performed from environmental information or biological information of the patient. Then, by determining whether to re-train the learning model as described above, the learning model can be re-trained at appropriate timing, allowing the prediction accuracy by the learning model to be maintained high. As a result, it is also applicable to support doctors in decision-making such as diagnosis.

### Sixth Example Embodiment

Next, a sixth example embodiment of the present disclosure will be described with reference to the drawings. In the present example embodiment, an outline of the determination device or the like described in the above example embodiments is illustrated. The drawings may relate to any example embodiment.

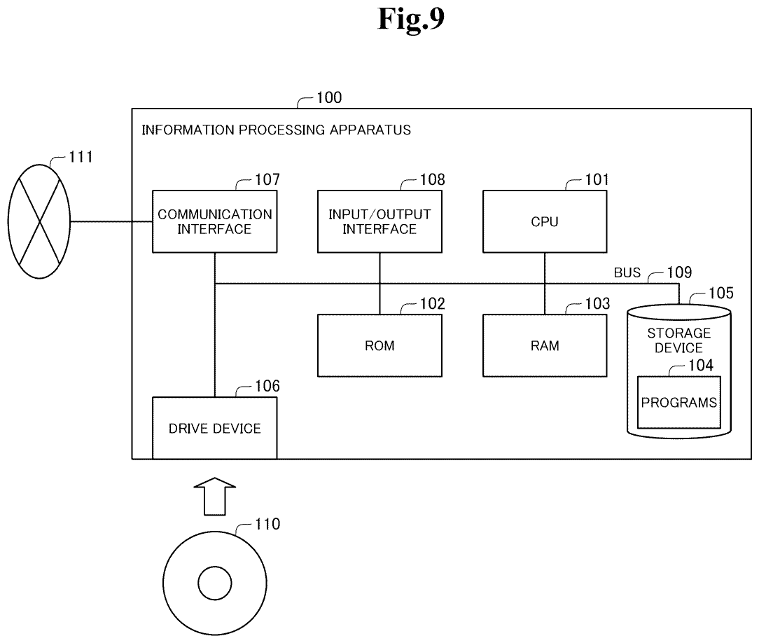

First, a hardware configuration of an information processing apparatus 100 in the present disclosure will be described. The information processing apparatus 100 is constituted by a general information processing apparatus and, in one example, is equipped with the hardware configuration as follows, as illustrated in FIG. 9.
Central processing unit (CPU) 101 (arithmetic device)
A read only memory (ROM) 102 (storage device)
A random access memory (RAM) 103 (storage device)
Programs 104 to be loaded into the RAM 103
A storage device 105 that stores the programs 104
A drive device 106 that performs reading and writing on a storage medium 110 outside the information processing apparatus
A communication interface 107 connected to a communication network 111 outside the information processing apparatus
An input/output interface 108 that inputs and outputs data
A bus 109 that connects each component

FIG. 9 illustrates an example of the hardware configuration of the information processing apparatus that is the information processing apparatus 100, and the hardware configuration of the information processing apparatus is not limited to the above case. For example, the information processing apparatus may be constituted by a part of the above configuration such as not including the drive device 106. The information processing apparatus can use, instead of the above-described CPU, a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

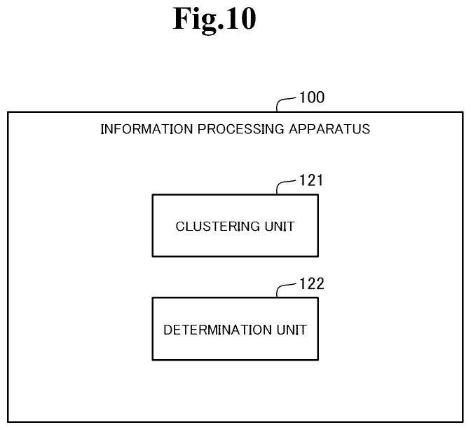

A clustering unit 121 and a determination unit 122 illustrated in FIG. 10 can be constructed and equipped in the information processing apparatus 100 by the CPU 101 acquiring and executing the programs 104. The programs 104 are stored in, for example, the storage device 105 or the ROM 102 in advance, and the CPU 101 loads and executes the programs 104 on the RAM 103, as necessary. The programs 104 may be supplied to the CPU 101 via the communication network 111, or the programs 104 may be stored in the storage medium 110 in advance and the drive device 106 may read the programs 104 and supply the read programs 104 to the CPU 101. However, the above-described clustering unit 121 and determination unit 122 may be constructed by a dedicated electronic circuit for achieving the means.

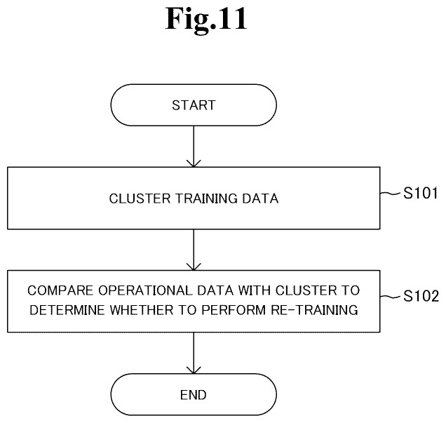

The clustering unit 121 clusters the training data used for the machine learning of the machine learning model into a plurality of clusters (step S101 in FIG. 11). The determination unit 122 determines whether to re-train the machine learning model based on comparison between the operational data used during operation of the machine learning model and each cluster (step S102 in FIG. 11).

In the above configuration, the information processing apparatus 100 clusters the training data and compares the clusters with the operational data. For example, the information processing apparatus 100 sets the range of each cluster by, for example, obtaining the maximum distance from the centroid of the cluster to a piece of training data belonging to the cluster, and checks whether the operational data is within that range of the cluster. In a case where there is data that falls outside the ranges of the clusters, it is possible to detect data drift of the operational data and determine to re-train the machine learning model. This enables performing re-training of the machine learning model at appropriate timing.

At least one of the above-described functions of the clustering unit 121 and the determination unit 122 may be executed by an information processing apparatus installed and connected at any place on a network, that is, may be executed on so-called cloud computing.

The above-described programs can be stored using various types of non-transitory computer readable media and supplied to a computer. The non-transitory computer readable media include various types of tangible storage media. Examples of the non-transitory computer readable medium include a magnetic recording medium (for example, a flexible disk, a magnetic tape, or a hard disk drive), an optical magnetic recording medium (for example, a magneto-optical disc), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber, or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the scope of the present disclosure. And each embodiment can be appropriately combined with other embodiments.

### SUPPLEMENTARY NOTE

Some or all of the above example embodiments may also be described as in the following Supplementary Notes. Hereinafter, an outline of configurations of the information processing apparatus, the information processing method, and the program in the present disclosure will be described. However, the present disclosure is not limited to the configurations described in the following supplementary notes.

Some or all of the configurations described in Supplementary Notes 2 to 8dependent on Supplementary Note 1 described below and the functions according to those configurations can also be dependent on other Supplementary Notes 9 and 10 by a dependency relationship similar to that of Supplementary Notes 2 to 8. Moreover, some or all of the configurations described in the Supplementary Notes and the functions according to those configurations can be made dependent not only on Supplementary Notes 1, 9, and 10, but also on similar hardware, software, various types of recording means for recording the software, or systems, without departing from the above-described example embodiments.

### Supplementary Note 1

An information processing apparatus including
a clustering unit that clusters training data used for machine learning of a machine learning model into a plurality of clusters, and
a determination unit that determines whether to re-train the machine learning model based on comparison between operational data used during operation of the machine learning model and the clusters.

### Supplementary Note 2

The information processing apparatus according to Supplementary Note 1,
wherein the clustering unit sets, for each cluster, a range of the cluster based on training data belonging to the cluster, and
the determination unit determines whether to re-train the machine learning model based on outlier data that is operational data that falls outside the ranges of the clusters.

### Supplementary Note 3

The information processing apparatus according to Supplementary Note 2,
wherein the determination unit determines whether to re-train the machine learning model based on the number of pieces of outlier data.

### Supplementary Note 4

The information processing apparatus according to Supplementary Note 2,
wherein the clustering unit approximates, for each cluster, the cluster to a certain shape based on the training data belonging to the cluster and sets the shape as the range of the cluster.

### Supplementary Note 5

The information processing apparatus according to Supplementary Note 2,
wherein the clustering unit sets, for each cluster, a distance from the centroid of the cluster to a certain piece of training data belonging to the cluster as the range of the cluster based on the pieces of training data belonging to the cluster.

### Supplementary Note 6

The information processing apparatus according to Supplementary Note 4,
wherein the clustering unit approximates, for each cluster, the area of the cluster to a shape of a convex polyhedron based on the training data belonging to the cluster and sets the shape as the range of the cluster.

### Supplementary Note 7

The information processing apparatus according to Supplementary Note 3,
wherein the determination unit calculates the number of pieces of input data obtained by subtracting the number of pieces of operational data that match the pieces of training data belonging to the clusters from the sum of the number of pieces of training data and the number of pieces of operational data, and determines whether to re-train the machine learning model based on the number of pieces of input data and the number of pieces of outlier data.

### Supplementary Note 8

The information processing apparatus according to Supplementary Note 3,
wherein the determination unit determines whether to re-train the machine learning model based on the sum of the number of pieces of training data and the number of pieces of operational data, and the sum of the number of pieces of outlier data and the number of incorrect prediction results provided by the machine learning model for the pieces of training data.

### Supplementary Note 9

An information processing method executed by an information processing apparatus, the method including
clustering training data used for machine learning of a machine learning model into a plurality of clusters, and
determining whether to re-train the machine learning model based on comparison between operational data used during operation of the machine learning model and the clusters.

### Supplementary Note 10

A program that causes an information processing apparatus to execute processing including
clustering training data used for machine learning of a machine learning model into a plurality of clusters, and
determining whether to re-train the machine learning model based on comparison between operational data used during operation of the machine learning model and the clusters.

### REFERENCE SIGNS LIST

10 determination device
11 clustering unit
12 pre-calculation unit
13 outlier determination unit
14 alert issuing unit
15 training data pre-calculation table
16 determination result DB
20 prediction device
21 training data
22 pre-trained model
23 training unit
24 learning model
25 prediction unit
30 target system
31 log data
100 information processing apparatus
101 CPU
102 ROM
103 RAM
104 programs
105 storage device
106 drive device
107 communication interface
108 input/output interface
109 bus
110 storage medium
111 communication network
121 clustering unit
122 determination unit

1. An information processing apparatus comprising:
at least one memory configured to store processing instructions; and
at least one processor configured to execute the processing instructions to:
cluster training data used for machine learning of a machine learning model into a plurality of clusters, and
determine whether to re-train the machine learning model based on comparison between operational data used during operation of the machine learning model and the clusters.

2. The information processing apparatus according to claim 1, wherein the at least one processor is configured to execute the processing instructions to
set, for each cluster, a range of the cluster based on training data belonging to the cluster, and
determine whether to re-train the machine learning model based on outlier data that is operational data that falls outside the ranges of the clusters.

3. The information processing apparatus according to claim 2, wherein the at least one processor is configured to execute the processing instructions to
determine whether to re-train the machine learning model based on the number of pieces of outlier data.

4. The information processing apparatus according to claim 2, wherein the at least one processor is configured to execute the processing instructions to
approximate, for each cluster, the cluster to a certain shape based on the training data belonging to the cluster and set the shape as the range of the cluster.

5. The information processing apparatus according to claim 2, wherein the at least one processor is configured to execute the processing instructions to
set, for each cluster, a distance from the centroid of the cluster to a certain piece of training data belonging to the cluster as the range of the cluster based on the pieces of training data belonging to the cluster.

6. The information processing apparatus according to claim 4, wherein the at least one processor is configured to execute the processing instructions to
approximate, for each cluster, the area of the cluster to a shape of a convex polyhedron based on the training data belonging to the cluster and set the shape as the range of the cluster.

7. The information processing apparatus according to claim 3, wherein the at least one processor is configured to execute the processing instructions to
calculate the number of pieces of input data obtained by subtracting the number of pieces of operational data that match the pieces of training data belonging to the clusters from the sum of the number of pieces of training data and the number of pieces of operational data, and determine whether to re-train the machine learning model based on the number of pieces of input data and the number of pieces of outlier data.

8. The information processing apparatus according to claim 3, wherein the at least one processor is configured to execute the processing instructions to
determine whether to re-train the machine learning model based on the sum of the number of pieces of training data and the number of pieces of operational data, and the sum of the number of pieces of outlier data and the number of incorrect prediction results provided by the machine learning model for the pieces of training data.

9. An information processing method executed by an information processing apparatus, the method comprising:
clustering training data used for machine learning of a machine learning model into a plurality of clusters, and
determining whether to re-train the machine learning model based on comparison between operational data used during operation of the machine learning model and the clusters.

10. The information processing method according to claim 9, further comprising, by the information processing apparatus,
setting, for each cluster, a range of the cluster based on training data belonging to the cluster, and
determining whether to re-train the machine learning model based on outlier data that is operational data that falls outside the ranges of the clusters.

11. The information processing method according to claim 10, further comprising, by the information processing apparatus,
determining to re-train the machine learning model based on the number of pieces of outlier data.

12. The information processing method according to claim 10, further comprising, by the information processing apparatus,
approximating, for each cluster, the cluster to a certain shape based on the training data belonging to the cluster and setting the shape as the range of the cluster.

13. The information processing method according to claim 10, further comprising, by the information processing apparatus,
setting, for each cluster, a distance from the centroid of the cluster to a certain piece of training data belonging to the cluster as the range of the cluster based on the pieces of training data belonging to the cluster.

14. The information processing method according to claim 12, further comprising, by the information processing apparatus,
approximating, for each cluster, the area of the cluster to a shape of a convex polyhedron based on the training data belonging to the cluster and setting the shape as the range of the cluster.

15. The information processing method according to claim 11, further comprising, by the information processing apparatus,
calculating the number of pieces of input data by subtracting the number of pieces of operational data that match the pieces of training data belonging to the clusters from the sum of the number of pieces of training data and the number of pieces of operational data, and determining whether to re-train the machine learning model based on the number of pieces of input data and the number of pieces of outlier data.

16. The information processing method according to claim 11, further comprising, by the information processing apparatus,
determining whether to re-train the machine learning model based on the sum of the number of pieces of training data and the number of pieces of operational data, and the sum of the number of pieces of outlier data and the number of incorrect prediction results provided by the machine learning model for the pieces of training data.

17. A non-transitory computer-readable storage medium storing a program that causes an information processing apparatus to execute processing comprising:
clustering training data used for machine learning of a machine learning model into a plurality of clusters, and
determining whether to re-train the machine learning model based on comparison between operational data used during operation of the machine learning model and the clusters.
